(19) United States
(12) Patent Application Publication
(10) Pub. No.: US 2018/0367756 A1
(43) Pub. Date: Dec. 20, 2018

(54) Video conference system utilizing transparent screen

(71) Applicant: Shenzhen Optical Crystal LTD, Co., SHENZHEN (CN)

(72) Inventor: YONGJING WANG, SHENZHEN (CN)

(21) Appl. No.: 16/006,832

(22) Filed: Jun. 12, 2018

Related U.S. Application Data
(60) Provisional application No. 62/520,005, filed on Jun. 15, 2017.

(51) Int. Cl. H04N 7/15

(52) U.S. Cl. CPC H04N 7/15

(57) ABSTRACT

Present patent application discloses a video conference system utilizing a transparent display to enable eye contacting between different participants. The video conference system comprises multiple terminals at different locations, each terminal comprises 1) a transparent display showing the image from other terminal; 2) a camera located behind the transparent displays, which catches the video signal of a users located at same location. The camera is located substantially close to the eyes of image of the participant at other location. So a good eye contacting can be maintained for all participants. This video conference system can be used widely for better communication.

### CROSS-REFERENCE TO RELATED APPLICATIONS

This application claims priority of U.S. Provisional Patent Application No. 62/520,005, filed Jun. 15, 2017, the entire contents of which are incorporated herein by reference.

### TECHNICAL FIELD OF THE INVENTION

The present invention relates to an optical display system, more specifically to a video conference system.

### BACKGROUND OF THE INVENTION

Video conference systems have been used widely to save communication cost. People prefer a video conference call with a user experience as similar as possible like a real meeting. In a real meeting, not only the audio and video, but also the eye contact is important. Nowadays, a video conference system generally has a camera placed above, below, or at side of a display device. Because all traditional display devices are not transparent, the camera can't be placed behind the display. The camera is not in line with the line of vision of the user. Therefore, a person on the other end would see the user's image looking above or below and not making direct eye contact with them. As a result, video conferences would feel that their counterparts are talking to someone else and not to them. This problem arises because the speaker looks mainly at their counterpart's picture instead of at the camera. Lack of eye contact is a considerable obstacle to the feel of a ‘real’ conversation in video conference systems now.

Only larger companies are able to afford the luxury of creating artificial eye contact during video conferences; this has required complex mirror systems or several cameras and special software. No satisfactory solution to the problem has existed.

There is a need for video conference system allowing for natural eye contact.

### SUMMARY OF THE INVENTION

A primary object of the present invention is to solve the problems associated with the above-referenced related art. It is another object to provide an improved video conference system. It is still another object to provide a video conference system which gives a realistic feel of communication between video conferences by allowing users to make eye contact.

The present patent application discloses a video conference system utilizing a transparent screen. In first embodiment, the video conference system comprises multiple terminals at different locations, each terminal comprises 1) a transparent display showing the image from other terminal; 2) a camera located behind the transparent displays, which catches the video signal of a users located at same location. The video signal is sent to other terminal at other location and displayed on other transparent display. In the terminal at the each location, the camera is located substantially close to the eyes of the image of the participant at the other location. When the participant in the first location looks at the eyes of the image of the participant in the second location, the camera also is in line with that line of vision. Therefore the participant in the second location can see the eyes of the participant at the first location through the camera, and vice versa. Good eye contact can be martainned for all participants.

In a further embodiment, the transparent display is a transparent flat panel display like LCD or OLED. In another embodiment, the transparent display further comprises a transparent screen and a projector. Those skilled in the art appreciate that the concepts and specific embodiments disclosed herein can be modified, such as by using different transparent display technology, while carrying out the same essential purposes of the present invention. Such equivalent constructions are encompassed by the disclosure of the invention and do not depart from the spirit and scope of the invention in its broadest form.

In another embodiment, the transparent screen and the projector work in a front projection mode. To avoid the light from the projector passing through the screen to wash out the image caught by the camera, the projector further comprises of a polarizer aligned at first angle. The camera further comprises a polarizer aligned perpendicular to the first angle. Therefore the camera only catches the image of the first participant at same location. The light from the projector is blocked.

In another embodiment, the transparent screen and the projector work in a rear projection mode.

In further embodiment, the video conference system comprises an adjustable mount for the camera so that the position and the viewing angle of the camera can be adjusted. This ensures it is always behind the eye of the displayed image to maintain good eye contact.

In further embodiment, the video conference system further comprises an image processing system to adjust the position and the viewing angle of the camera in software.

In further embodiment, the transparent display is a 3D display and the camera is a 3D camera. In another embodiment, the video conference system comprises a transparent projection screen that can maintain the polarization of projected image. The projector generates multiple images for right and left eyes of the participant. The participant wears passive or active glasses to view a 3D image of the other participant.

Those skilled in the art appreciate that the concepts and specific embodiments disclosed herein can be modified, such as by using different 3D display technologies, while carrying out the same essential purposes of the present invention. Some of the 3D display technology needs wear a passive or active glasses; some of the 3D display technologies can be seen through naked eyes. Those skilled in the art will also realize that such equivalent constructions do not depart from the spirit and scope of the invention in its broadest form.

In further embodiment, the video conference system wherein said transparent display works in a time multiplexing way. In some time period, the transparent display generates an image; in some time period, the transparent display is transparent to allow the camera to catch the image of the user. The camera also works in time multiplexing way corresponding to the transparent display.

### BRIEF DESCRIPTION OF THE DRAWINGS

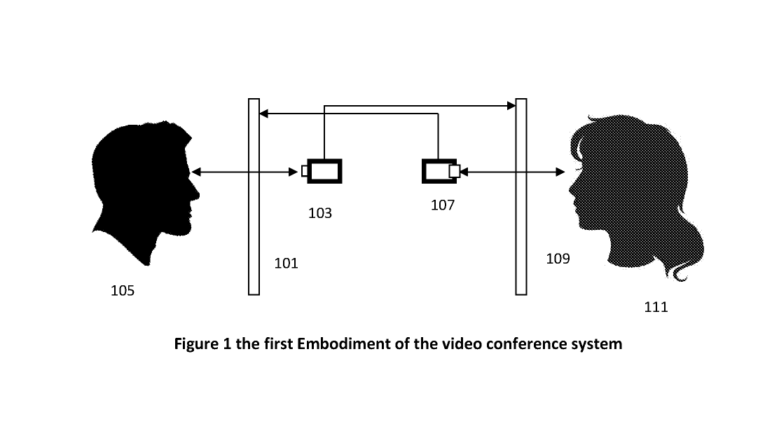

FIG. 1: The first embodiment of video conference system,
105 and 111: the participant at different terminals
101 and 109: transparent display
103 and 107: Camera

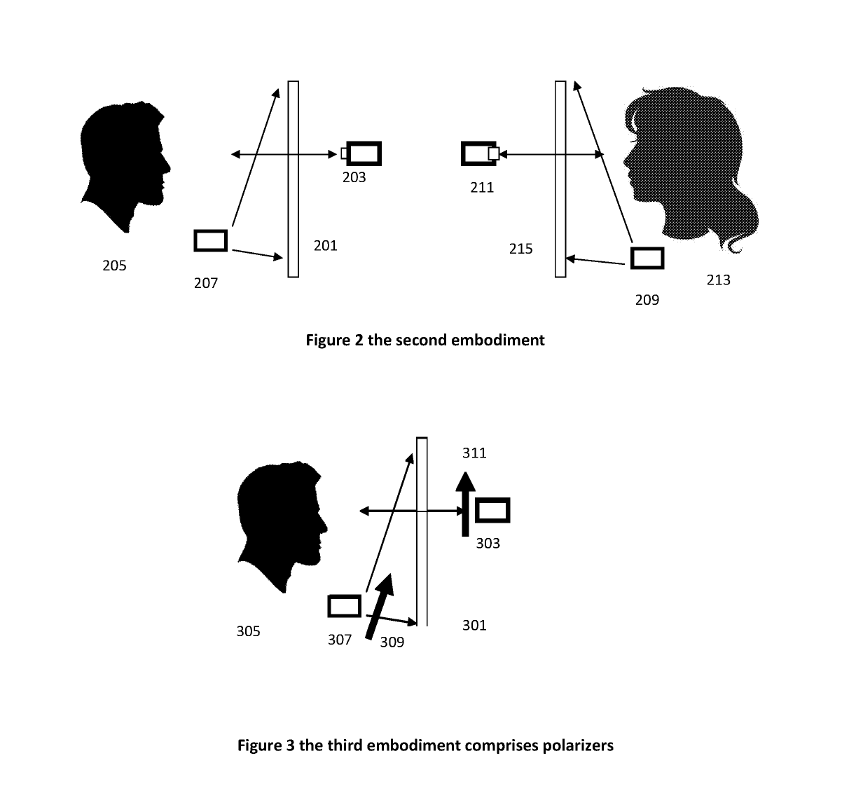

FIG. 2: The second embodiment of video conference system
205 and 213: the participant at different terminals
201 and 215: transparent screens
207 and 209: projectors
203 and 211: camera

FIG. 3: Further embodiment comprising polarizers to avoid projected light entering into the camera;
301 transparent screens
303 cameras
305 the participant at different terminals
307 projectors
309 polarizer at one orientation;
311 polarizer at another orientation

### DETAILED DESCRIPTION OF THE INVENTION

The first embodiment of the present patent, as shown in FIG. 1, comprises multiple terminals at different location, each terminal comprises 1) a transparent display (101 and 109) showing the image from other terminal; 2) a camera (103 and 107) located behind the transparent displays (101 and 109), which catches the video signal of a users (105 and 111) located at same location, 3) a controller and communication means (not showing in the figure). The video signal caught by the camera is sent to the other terminal at the other location and displayed on other transparent display. In the terminal at the each location, the camera (103 and 107) is located substantially close to the eyes of image of the participant at the other location. When the participant in the first location looks at the eyes of the image of the participant in the second location, the camera also is in line with the line of vision of this participant. Therefore the participant in the second location can see the eyes of the participant at the first location through the camera, and vice versa. Good eye contact can be maintained for all participants.

The second embodiment of the present patent, as shown in FIG. 2, wherein the transparent display is implemented using a transparent projection screen 201 and projector 207. The projector can work at either rear projection mode where the projector and viewer are located at different sides of the projection screen, or front projection mode where the projector and viewer are located at the same side of the projection screen. In a further embodiment, as shown in FIG. 3, the video conference system further comprises a polarizer 309 in the front of the projector 307 and a perpendicular polarizer 311 in the front of the camera 303. Therefore the camera 303 only catches the image of participant at the same terminal. The light from projector 307 will not enter into the camera 303 to avoid image of the participant being washed out.

I claim:

1. A video conference system comprises multiple terminals at different locations, each terminal comprises at least 1) a transparent display that displays the image of another user at another locations, 2) a camera located behind the transparent displays and is substantially close to the eye's positions, 3) a controller and communication means.

2. The video conference system as described in claim 1, wherein said transparent display is a partially transparent flat panel display.

3. The video conference system as described in claim 1, wherein said transparent display further comprises a transparent projection screen and a projector.

4. The video conference system as described in claim 3, further comprises a polarizer in front of projector and a polarizer in front of the camera.

5. The video conference system as described in claim 1, wherein said transparent display produces 3D images.

6. The video conference system as described in claim 3, wherein said transparent projection screen maintain the polarization and said projector generate multiple images for right and left eyes of the participant.

7. The video conference system as described in claim 1, wherein said transparent display works in time multiplexing way, in some time period said transparent display generates a image, in some time period said transparent display is switched to transparent state to allow the camera to catch the image, said camera also works in time multiplexing way corresponding to the said transparent display.

8. The video conference system as described in claim 1, wherein said camera further comprises an adjustable mount so that the position and the viewing angle of the camera can be adjusted.

9. The video conference system as described in claim 1, wherein said camera further comprises an image processing system to adjust the position and the viewing angle of the camera in software.
